(19) United States
(12) Patent Application Publication
(10) Pub. No.: US 2026/0348655 A1
(43) Pub. Date: Nov. 5, 2026

(54) GAS MANAGEMENT SYSTEM

(71) Applicants: SAMSUNG HEAVY IND. CO., LTD., Gyeonggi-do (KR); PETROLIAM NASIONAL BERHAD (PETRONAS), Kuala Lumpur (MY)

(72) Inventors: Chulwoo KIM, Gyeongsangnam-do (KR); Mungyu KIM, Gyeongsangnam-do (KR); Kideok NAM, Gyeongsangnam-do (KR); Sungwook HWANG, Gyeongsangnam-do (KR); Fauzi Bin Md NORDIN, Kuala Lumpur (MY); Khairul Nizam B ARIFIN, Kuala Lumpur (MY); Mohd Zwockerie B Mohd SUPLI, Kuala Lumpur (MY); Muhamad Saifuddin BIN SIDEK, Kuala Lumpur (MY)

(73) Assignees: SAMSUNG HEAVY IND. CO., LTD., Gyeonggi-do (KR); PETROLIAM NASIONAL BERHAD (PETRONAS), Kuala Lumpur (MY)

(21) Appl. No.: 19/488,619

(22) PCT Filed: Oct. 13, 2023
(86) PCT No.: PCT/KR2023/015823

§ 371 Date: Nov. 27, 2025

(30) Foreign Application Priority Data
May 31, 2023 (KR) 10-2023-0070446

(51) Int. Cl. F25J 3/08; F17C 13/00; F25J 1/00; F25J 3/06

(52) U.S. Cl. CPC F25J 3/08; F17C 13/001; F25J 1/0022; F25J 1/0035; F25J 3/0635; F25J 3/065; F17C 2221/033; F17C 2227/0337; F25J 1/0047; F25J 2210/60; F25J 2220/64; F25J 2240/02; F25J 2245/90

(57) ABSTRACT

A gas management system is disclosed. The gas management system according to the present embodiment includes a natural gas processing apparatus configured to separate heavy hydrocarbons contained in natural gas and a natural gas liquefaction apparatus configured to provide cold energy to the natural gas, and may reduce facility building and operation costs because the heavy hydrocarbons are separated by receiving the cold energy during a process of liquefying the natural gas without building a separate facility for separating the heavy hydrocarbons from the natural gas.

### TECHNICAL FIELD

The present invention relates to a gas management system, and more particularly, to a gas management system for processing and liquefying natural gas through a plurality of refrigerant cycles using different refrigerants.

### BACKGROUND ART

As regulations of the International Maritime Organization (IMO) regarding the emission of greenhouse gases and various air pollutants are strengthened, in the shipbuilding and shipping industries, natural gas, which is a clean energy source, is increasingly being used as fuel gas for ships instead of using heavy oil and diesel oil, which are existing fuels.

Generally, for ease of storage and transportation, natural gas is cooled to about −163 °C for phase change to liquefied natural gas, and then filled in a storage tank of a ship to be used as fuel gas of an engine or various facilities or transported to a faraway demanding site. Thus, liquefied natural gas is obtained by being cooled to an ultra low temperature and has a volume reduced to about 1/600 of that of gaseous natural gas, and thus may be very suitable for transportation and handling.

Meanwhile, natural gas contains not only methane (C1) and ethane (C2) but also heavy hydrocarbons such as a hydrocarbon (C4+) with four or more carbon atoms, benzene, toluene, ethylbenzene, xylene, and the like, and such heavy hydrocarbons have a problem in that they block a gas transfer pipe or cause a failure in various facilities by being solidified at a relatively high temperature when the natural gas is cooled for liquefaction.

Consequently, for stable and efficient management and handling of natural gas, a method capable of separating heavy hydrocarbons from natural gas and liquefying the natural gas at the same time is required.

### DISCLOSURE

### Technical Problem

The present embodiment is directed to providing a gas management system capable of simultaneously performing separation of heavy hydrocarbons and liquefaction of natural gas.

The prevent embodiment is directed to providing a gas management system capable of reducing facility building cost and promoting easy and efficiency of operation.

The present embodiment is directed to providing a gas management system capable of promoting stable handling and management of natural gas.

The present embodiment is directed to providing a gas management system capable of improving liquefaction efficiency of natural gas.

The present embodiment is directed to providing a gas management system capable of facilitating control of a liquefaction process.

### Technical Solution

One aspect of the present invention provides a gas management system including: a natural gas processing apparatus configured to separate heavy hydrocarbons contained in natural gas; and a natural gas liquefaction apparatus configured to provide cold energy to the natural gas, and the natural gas liquefaction apparatus may include a cryogenic heat exchanger in which the natural gas passes through and is liquefied into liquefied natural gas (LNG) through heat exchange with a first refrigerant and a second refrigerant, a first refrigerant cycle in which the first refrigerant circulates, some paths pass through the cryogenic heat exchanger to perform heat exchange, and a path of the first refrigerant is divided into a plurality of paths after performing heat exchange in the cryogenic heat exchanger to perform expansion and pre-compression of the first refrigerant, and a second refrigerant cycle in which the second refrigerant circulates and some paths pass through the cryogenic heat exchanger, the first refrigerant cycle may include a first refrigerant first compression part provided upstream of the cryogenic heat exchanger and configured to compress the first refrigerant to a high pressure, a first refrigerant first turbo expander including a first refrigerant first expansion part provided downstream of the cryogenic heat exchanger and configured to expand a first flow of two divided flows of the first refrigerant having passed through the cryogenic heat exchanger, and a first refrigerant first pre-compression part configured to pre-compress the first refrigerant which has been expanded by the first refrigerant first expansion part and has passed through the cryogenic heat exchanger again, a first refrigerant second turbo expander including a first refrigerant second expansion part provided downstream of the cryogenic heat exchanger and configured to expand a second flow of the two divided flows of the first refrigerant having passed through the cryogenic heat exchanger and a first refrigerant second pre-compression part configured to pre-compress the first refrigerant which has been expanded by the first refrigerant second expansion part and has passed through the cryogenic heat exchanger again, and a mixing pipe where the first flow of the first refrigerant pre-compressed by the first refrigerant first pre-compression part and the second flow of the first refrigerant pre-compressed by the first refrigerant second pre-compression part are mixed, the natural gas processing apparatus may include a scrub column configured to receive natural gas firstly cooled through heat exchange performed in the cryogenic heat exchanger and firstly separate the natural gas into a gas component and a liquid component while the introduced natural gas passes through the cryogenic heat exchanger and performs heat exchange, and a reflux drum configured to receive secondarily cooled natural gas through heat exchange performed in the cryogenic heat exchanger and secondarily separate the natural gas into a gas component and a liquid component while the gas component separated at the scrub column passes through the cryogenic heat exchanger and performs heat exchange, and the gas component separated at the reflux drum may be thirdly cooled and liquefied by passing through the cryogenic heat exchanger and performing heat exchange.

The liquid component separated at the reflux drum may be introduced into the scrub column.

The scrub column may include an upper section and a middle section, and the natural gas firstly cooled by performing heat exchange in the cryogenic heat exchanger may be introduced into the middle section.

The liquid component separated at the reflux drum may be introduced into the upper section.

The liquid component separated at the reflux drum may be sprayed in the upper section.

The natural gas processing apparatus may further include a reflux pump configured to pressurize the liquid component separated at the reflux drum and send the liquid component to the scrub column.

The scrub column may include a reboiler configured to heat the liquid component firstly separated at the scrub column.

The scrub column may further include a lower section, and the reboiler may be provided in the lower section.

The first flow of the first refrigerant expanded by the first refrigerant first expansion part may be introduced into an upstream region among the upstream region, a midstream region, and a downstream region in the cryogenic heat exchanger with respect to the flow of the natural gas, and pass through the upstream region without passing through the downstream region and the midstream region and then be introduced into the first refrigerant first pre-compression part, the second flow of the first refrigerant expanded by the first refrigerant second expansion part may be introduced into the midstream region in the cryogenic heat exchanger, and sequentially pass through the midstream region and the upstream region without passing through the downstream region and then be introduced into the first refrigerant second pre-compression part, the second refrigerant cycle may have the second refrigerant sequentially passing through the downstream region, the midstream region, and the upstream region among the regions in the cryogenic heat exchanger with respect to the flow of the natural gas, and the natural gas introduced into the natural gas processing apparatus may be introduced into and pass through the upstream region in the cryogenic heat exchanger and then be introduced into the scrub column.

The gas component separated at the scrub column may be introduced into and pass through the midstream region in the cryogenic heat exchanger and then be introduced into the reflux drum.

The gas component separated at the reflux drum may be introduced into the cryogenic heat exchanger and cooled and liquefied by sequentially passing through the upper region, the midstream region, and the downstream region.

The second refrigerant cycle may include a second refrigerant compression part provided upstream of the cryogenic heat exchanger and configured to compress the second refrigerant to a high pressure and a second refrigerant turbo expander including a second refrigerant expansion part provided downstream of the cryogenic heat exchanger and configured to expand the second refrigerant having passed through the cryogenic heat exchanger and a second refrigerant pre-compression part configured to pre-compress the second refrigerant which has been expanded by the second refrigerant expansion part and has passed through the cryogenic heat exchanger again.

The first refrigerant may include methane or LNG boil-off gas, and the second refrigerant may include nitrogen.

The liquid component separated at the scrub column may be produced as natural gas condensate.

The first refrigerant first compression part may be provided as a plurality of first refrigerant first compression parts, and the first refrigerant mixed in the mixing pipe may be introduced into a first refrigerant first compression part of the first refrigerant first compression parts connected in series.

Another aspect of the present invention provides a gas management system includes: a natural gas processing apparatus configured to separate heavy hydrocarbons contained in natural gas; and a natural gas liquefaction apparatus configured to provide cold energy to the natural gas, and the natural gas liquefaction apparatus may include a cryogenic heat exchanger in which the natural gas passes through and is liquefied into LNG through heat exchange with a first refrigerant and a second refrigerant, a first refrigerant cycle in which the first refrigerant circulates, some paths pass through the cryogenic heat exchanger to perform heat exchange, and a path of the first refrigerant is divided into a plurality of paths after performing heat exchange in the cryogenic heat exchanger to perform expansion and pre-compression of the first refrigerant, and a second refrigerant cycle in which the second refrigerant circulates and some paths pass through the cryogenic heat exchanger, the first refrigerant cycle may include a first refrigerant first compression part provided upstream of the cryogenic heat exchanger and configured to compress the first refrigerant to a high pressure, a first refrigerant first turbo expander including a first refrigerant first expansion part provided downstream of the cryogenic heat exchanger and configured to expand a first flow of two divided flows of the first refrigerant having passed through the cryogenic heat exchanger, and a first refrigerant first pre-compression part configured to pre-compress the first refrigerant which has been expanded by the first refrigerant first expansion part and has passed through the cryogenic heat exchanger again, a first refrigerant second turbo expander including a first refrigerant second expansion part provided downstream of the cryogenic heat exchanger and configured to expand a second flow of the two divided flows of the first refrigerant having passed through the cryogenic heat exchanger and a first refrigerant second pre-compression part configured to pre-compress the first refrigerant which has been expanded by the first refrigerant second expansion part and has passed through the cryogenic heat exchanger again, and a mixing pipe where the first flow of the first refrigerant pre-compressed by the first refrigerant first pre-compression part and the second flow of the first refrigerant pre-compressed by the first refrigerant second pre-compression part are mixed, the natural gas processing apparatus may include a scrub column configured to receive natural gas firstly cooled through heat exchange performed in the cryogenic heat exchanger and firstly separate the natural gas into a gas component and a liquid component while the introduced natural gas passes through the cryogenic heat exchanger and performs heat exchange, and a reflux drum configured to receive a first flow of two divided flows of the gas component separated at the scrub column and secondarily cooled by performing heat exchange in the cryogenic heat exchanger, the first flow performing heat exchange by passing through the cryogenic heat exchanger, and a second flow of the two divided flows of the gas component separated at the scrub column may be secondarily cooled and liquefied by passing through the cryogenic heat exchanger and performing heat exchange.

The reflux drum may receive the cooled first flow and secondarily separate the liquid component.

The reflux drum may receive the cooled first flow and secondarily separate the gas component.

The liquid component separated at the reflux drum may be introduced into the scrub column.

The scrub column may include an upper section and a middle section, and the natural gas firstly cooled by performing heat exchange in the cryogenic heat exchanger may be introduced into the middle section.

The liquid component separated at the reflux drum may be introduced into the upper section.

The liquid component separated at the reflux drum may be sprayed in the upper section.

The natural gas processing apparatus may further include a reflux pump configured to pressurize the liquid component separated at the reflux drum and send the liquid component to the scrub column.

The scrub column may include a reboiler configured to heat the liquid component firstly separated at the scrub column.

The scrub column may further include a lower section, and the reboiler may be provided in the lower section.

The first flow of the first refrigerant expanded by the first refrigerant first expansion part may be introduced into an upstream region among the upstream region, a midstream region, and a downstream region in the cryogenic heat exchanger with respect to the flow of the natural gas, and pass through the upstream region without passing through the downstream region and the midstream region and then be introduced into the first refrigerant first pre-compression part, the second flow of the first refrigerant expanded by the first refrigerant second expansion part may be introduced into the midstream region in the cryogenic heat exchanger, and sequentially pass through the midstream region and the upstream region without passing through the downstream region and then be introduced into the first refrigerant second pre-compression part, the second refrigerant cycle may have the second refrigerant sequentially passing through the downstream region, the midstream region, and the upstream region among the regions in the cryogenic heat exchanger with respect to the flow of the natural gas, and the natural gas introduced into the natural gas processing apparatus may be introduced into and pass through the upstream region in the cryogenic heat exchanger and then be introduced into the scrub column.

The first flow of the gas component separated at the scrub column may be introduced into and pass through the midstream region in the cryogenic heat exchanger and then be introduced into the reflux drum.

The second flow of the gas component separated at the scrub column may be cooled and liquefied by sequentially passing through the midstream region and the downstream region in the cryogenic heat exchanger.

The second refrigerant cycle may include a second refrigerant compression part provided upstream of the cryogenic heat exchanger and configured to compress the second refrigerant to a high pressure and a second refrigerant turbo expander including a second refrigerant expansion part provided downstream of the cryogenic heat exchanger and configured to expand the second refrigerant having passed through the cryogenic heat exchanger and a second refrigerant pre-compression part configured to pre-compress the second refrigerant which has been expanded by the second refrigerant expansion part and has passed through the cryogenic heat exchanger again.

The first refrigerant may include methane or LNG boil-off gas, and the second refrigerant may include nitrogen.

The liquid component separated at the scrub column may be produced as natural gas condensate.

The first refrigerant first compression part may be provided as a plurality of first refrigerant first compression parts, and the first refrigerant mixed in the mixing pipe may be introduced into a first refrigerant first compression part of the first refrigerant first compression parts connected in series.

### Advantageous Effects

A gas management system according to the present embodiment can simultaneously perform separation of heavy hydrocarbons and liquefaction of natural gas.

A gas management system according to the present embodiment can reduce facility building cost and promote efficiency of operation.

A gas management system according to the present embodiment can promote stable handling and management of natural gas.

A gas management system according to the present embodiment can improve liquefaction efficiency of natural gas.

A gas management system according to the present embodiment can facilitate better control of a liquefaction process.

A gas management system according to the present embodiment can produce natural gas condensate.

### DESCRIPTION OF DRAWINGS

FIG. 1 is a conceptual diagram illustrating a gas management system according to a first embodiment of the present invention.

FIG. 2 is a graph illustrating a composite curve of a cryogenic heat exchanger applied to a conventional natural gas liquefaction apparatus.

FIG. 3 is a view illustrating a composite curve of a cryogenic heat exchanger applied to a natural gas liquefaction apparatus according to the present embodiment.

FIG. 4 is a conceptual diagram illustrating a gas management system according to a second embodiment of the present invention.

### MODES OF THE INVENTION

Hereinafter, embodiments of the present disclosure will be described in detail with reference to the accompanying drawings. The following embodiments are provided to fully convey the spirit of the present disclosure to a person having ordinary skill in the art to which the present disclosure belongs. The present disclosure is not limited to the embodiments shown herein but may be embodied in other forms. The drawings may omit the illustration of parts not related to the description in order to clarify the present disclosure, and slightly exaggerate the size of the components to help understanding.

For ease of storage and transportation, natural gas is cooled to an ultra low temperature for phase change to liquefied natural gas (LNG) and then is supplied to various demanding sites, a storage tank of a ship, or the like. Natural gas contains not only methane (C1) and ethane (C2) but also heavy hydrocarbons such as a hydrocarbon (C4+) having four or more carbon atoms and aromatic hydrocarbons (for example, benzene, toluene, ethylbenzene, xylene, and the like), and since such heavy hydrocarbons may block a gas transfer pipe or cause a failure of a facility by being solidified at a relatively high temperature when the natural gas is cooled for liquefaction, it is required to separate the heavy hydrocarbons contained in natural gas. In addition, removal of heavy hydrocarbons such as butane (C4H10) and pentane (C5H12) may be needed according to an LNG specification required by a demanding site or an engine of a ship.

Accordingly, in gas management systems 1 and 2 according to the present embodiment, a method capable of efficiently liquefying natural gas and effectively separating heavy hydrocarbons contained therein at the same time is required.

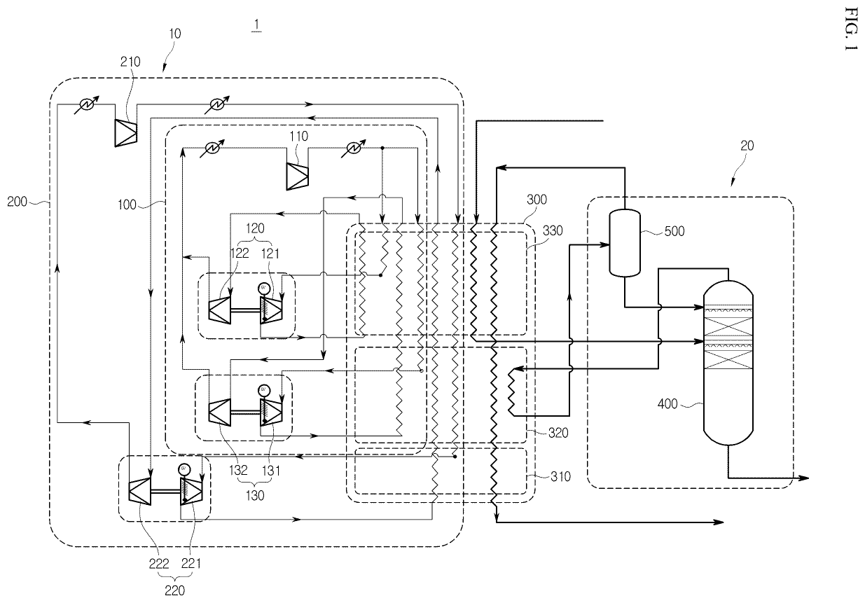

FIG. 1 is a conceptual diagram illustrating the gas management system 1 according to a first embodiment of the present invention.

Referring to FIG. 1, the gas management system 1 according to the first embodiment of the present invention may include a natural gas processing apparatus 20 configured to separate heavy hydrocarbons contained in natural gas and a natural gas liquefaction apparatus 10 configured to promote separation of the heavy hydrocarbons and implement liquefaction of the natural gas by providing cold energy to the natural gas.

The natural gas processing apparatus 20 is provided to receive gaseous natural gas from a supply source such as a gas well and the like and separate and process heavy hydrocarbons. The natural gas processing apparatus 20 may receive cold energy from the natural gas liquefaction apparatus 10 to be described below and liquefy and separate the heavy hydrocarbons from the natural gas while liquefying the natural gas. That is, the natural gas processing apparatus 20 according to the present embodiment does not separate the heavy hydrocarbons through a separate process from a liquefaction process by the natural gas liquefaction apparatus 10 to be described below but separates the heavy hydrocarbons using cold energy for the liquefaction process so that a heavy hydrocarbon separation process and a natural gas liquefaction process may be performed simultaneously. A detailed description thereabout will be presented below.

The natural gas liquefaction apparatus 10 may include a cryogenic heat exchanger 300, a first refrigerant cycle 100, and a second refrigerant cycle 200. The cryogenic heat exchanger 300, through which natural gas passes through the natural gas processing apparatus 20 to be described below, may liquefy the natural gas to liquified natural gas while separating heavy hydrocarbons from the natural gas through heat exchange with a first refrigerant circulating through the first refrigerant cycle 100 and a second refrigerant circulating through the second refrigerant cycle 200, and to this end, the cryogenic heat exchanger 300 may include a plurality of heat exchange parts for heat exchange between the natural gas processing apparatus 20 and the first refrigerant cycle 100 and the second refrigerant cycle 200.

The cryogenic heat exchanger 300 may be divided into a warm heat exchange region 330, an intermediate heat exchange region 320, and a cold heat exchange region 310 according to heat exchange temperature regions. Specifically, the intermediate heat exchange region 320 of the cryogenic heat exchanger 300 may perform heat exchange in a relatively lower temperature range than the warm heat exchange region 330, and the cold heat exchange region 310 may perform heat exchange in a relatively lower temperature range than the intermediate heat exchange region 320. As an example, a heat exchange temperature range of the warm heat exchange region 330 may correspond to about −75 °C to 30 °C, a heat exchange temperature range of the intermediate heat exchange region 320 may correspond to about −120 °C to −65 °C, and a heat exchange temperature range of the cold heat exchange region 310 may correspond to about −165 °C to −120 °C. That is, in the cryogenic heat exchanger 300, heat exchange may be performed at a gradually lower temperature from the warm heat exchange region 330 to the cold heat exchange region 310, and heavy hydrocarbons may be separated from natural gas with high separation efficiency, while natural gas may be liquefied with high liquefaction efficiency. A detailed description thereabout will be presented below. Meanwhile, with respect to a flow of natural gas transferred through the natural gas processing apparatus 20, the warm heat exchange region 330, the intermediate heat exchange region 320, and the cold heat exchange region 310 may be distinguished as an upstream region, a midstream region, and a downstream region, respectively.

In the present embodiment described hereinafter, the first refrigerant may be made of methane whose liquefaction point at atmospheric pressure corresponds to about −162 °C, and the second refrigerant may be made of nitrogen whose liquefaction point at atmospheric pressure corresponds to about −210 °C. However, the first refrigerant and the second refrigerant are not limited thereto, the first refrigerant may be made of LNG boil-off gas (BOG) generated by vaporization of natural gas stored in an LNG storage tank or LNG boil-off gas generated during a natural gas liquefaction process, and furthermore, the first refrigerant and the second refrigerant may of course be made of various types of refrigerants or inert gases as long as they may not only provide sufficient cold energy for liquefaction of natural gas but also have different liquefaction points to perform stepwise heat exchange.

The first refrigerant circulates through the first refrigerant cycle 100, some paths of which may perform heat exchange via the cryogenic heat exchanger 300. As described above, the first refrigerant may be a refrigerant having a liquefaction point higher than that of the second refrigerant, and the first refrigerant cycle 100 is provided to divide the path of the first refrigerant into a plurality of paths after performing heat exchange in the cryogenic heat exchanger 300 so that expansion and pre-compression of the first refrigerant may be performed. That is, the first refrigerant cycle 100 may have a parallel structure because the path of the first refrigerant is divided after passing through the cryogenic heat exchanger 300.

The first refrigerant cycle 100 may include a first refrigerant first compression part 110, a first turbo expander 120, and a second turbo expander 130.

The first refrigerant first compression part 110 is provided upstream of the cryogenic heat exchanger 300 in the first refrigerant cycle 100 and may compress the first refrigerant to a high pressure. For example, after passing through the first refrigerant first compression part 110, the first refrigerant may be compressed to a pressure level of about 50 to 60 barg. The first refrigerant first compression part 110 may be provided in a single stage, as illustrated in FIG. 1, and a cooler may be disposed on each of a front end side and a rear end side but is not limited thereto, and the first refrigerant first compression part 110 may be provided in a plurality of stages, a cooler may be alternately arranged therebetween, and the number thereof may be variously changed.

The first refrigerant compressed by the first refrigerant first compression part 110 may be divided into two flows, a first flow, which is a part of the two divided flows, may be cooled while passing through the warm heat exchange region 330 of the cryogenic heat exchanger 300, and a second flow, which is the remaining of the two divided flows, may be cooled while passing through the warm heat exchange region 330 of the cryogenic heat exchanger 300 and at least a part of the intermediate heat exchange region 320. At least one valve (not shown) may be provided at a point where the first refrigerant is divided into the two flows in the first refrigerant cycle 100 to adjust each of the first flow and the second flow. Meanwhile, in FIG. 1, the first refrigerant is illustrated to pass through the cryogenic heat exchanger 300 after being divided into the two flows, but is not limited thereto, and the first refrigerant may be divided into the two flows within the warm heat exchange region 330 of the cryogenic heat exchanger 300.

The two divided flows of the first refrigerant may meet again at the front end of the first refrigerant first compression part 110 after passing through the first turbo expander 120 and the second turbo expander 130 to be described below. Thus, as the first refrigerant cycle 100 has a parallel structure where the path of the first refrigerant is divided, control of a liquefaction process may be facilitated, and liquefaction efficiency of natural gas may be maximized.

The first flow of the first refrigerant compressed by the first refrigerant first compression part 110 exchanges heat and is cooled while passing through the warm heat exchange region 330 of the cryogenic heat exchanger 300, and then is supplied to a first refrigerant first expansion part 121 side of the first turbo expander 120. The first turbo expander 120 includes the first refrigerant first expansion part 121 and a first refrigerant first pre-compression part 122. The first refrigerant first expansion part 121 is provided downstream of the warm heat exchange region 330 of the cryogenic heat exchanger 300 in the first refrigerant cycle 100 and expands the first flow of the first refrigerant after passing through the cryogenic heat exchanger 300. As an example, the first flow of the first refrigerant may be expanded to about 10 to 16 barg by the first refrigerant first expansion part 121 and cooled to about −55 °C to −75 °C.

The first flow of the first refrigerant expanded and cooled by the first refrigerant first expansion part 121 circulates to the warm heat exchange region 330 side of the cryogenic heat exchanger 300 to perform heat exchange and provide cold energy. Specifically, the first flow of the first refrigerant, which is introduced from the first refrigerant first expansion part 121 to the cryogenic heat exchanger 300, may perform heat exchange and provide cold energy by passing through the warm heat exchange region 330 in the cryogenic heat exchanger 300 (upstream region among the regions in the cryogenic heat heat exchanger with respect to the flow of natural gas).

The first flow of the first refrigerant, which has passed through the warm heat exchange region 330 of the cryogenic heat exchanger 300, is supplied to the first refrigerant first pre-compression part 122. Like the first refrigerant first expansion part 121, the first refrigerant first pre-compression part 122 is provided downstream of the warm heat exchange region 330 of the cryogenic heat exchanger 300 in the first refrigerant cycle 100. The first refrigerant first pre-compression part 122 may preliminarily compress the supplied first flow of the first refrigerant. As an example, the first refrigerant first pre-compression part 122 may pre-compress the first flow of the first refrigerant, which has been expanded by the first refrigerant first expansion part 121 and has passed through the cryogenic heat exchanger 300 again, to about 20 to 27 barg and then supply the first flow to the first refrigerant first compression part 110.

The first refrigerant first pre-compression part 122 and the first refrigerant first expansion part 121 may be provided as companders or turbo expanders operating in conjunction with each other. That is, the first refrigerant first pre-compression part 122 and the first refrigerant first expansion part 121 may have drive shafts connected or linked with each other to use expansion energy of the first refrigerant as pressurizing energy, and thus the efficiency of facility operation may be improved and the energy efficiency thereof may be increased by reducing power consumption of the facility.

The second flow of the first refrigerant compressed by the first refrigerant first compression part 110 exchanges heat and is cooled while passing through the warm heat exchange region 330 of the cryogenic heat exchanger 300 and at least a part of the intermediate heat exchange region 320, and then is supplied to a first refrigerant second expansion part 131 side of the second turbo expander 130. The second turbo expander 130 includes the first refrigerant second expansion part 131 and a first refrigerant second pre-compression part 132. The first refrigerant second expansion part 131 is provided downstream of the warm heat exchange region 330 of the cryogenic heat exchanger 300 or downstream of the intermediate heat exchange region 320 in the first refrigerant cycle 100 and expands the second flow, which is the remaining part of the two divided flows of the first refrigerant, after passing through the cryogenic heat exchanger 300. As an example, the second flow of the first refrigerant may be expanded to about 15 to 22 barg by the first refrigerant second expansion part 131 and cooled to about −90 °C to −115 °C.

The second flow of the first refrigerant expanded and cooled by the first refrigerant second expansion part 131 circulates to the intermediate heat exchange region 320 and the warm heat exchange region 330 of the cryogenic heat exchanger 300 to perform heat exchange and provide cold energy. Specifically, the second flow of the first refrigerant, which is introduced from the first refrigerant second expansion part 131 to the cryogenic heat exchanger 300, may perform heat exchange and provide cold energy by sequentially passing through the intermediate heat exchange region 320 (midstream region among the regions in the cryogenic heat heat exchanger with respect to the flow of natural gas) and the warm heat exchange region 330 (upstream region) in the cryogenic heat exchanger 300.

The second flow of the first refrigerant, which has passed through the intermediate heat exchange region 320 and the warm heat exchange region 330 of the cryogenic heat exchanger 300, is supplied to the first refrigerant second pre-compression part 132. Like the first refrigerant second expansion part 131, the first refrigerant second pre-compression part 132 is provided downstream of the warm heat exchange region 330 of the cryogenic heat exchanger 300 in the first refrigerant cycle 100. The first refrigerant second pre-compression part 132 may preliminarily compress the supplied second flow of the first refrigerant. As an example, the first refrigerant second pre-compression part 132 may pre-compress the second flow of the first refrigerant, which has been expanded by the first refrigerant second expansion part 121 and has passed through the cryogenic heat exchanger 300 again, to about 20 to 27 barg and then supply the second flow to the first refrigerant first compression part 110.

The first flow of the first refrigerant pre-compressed by the first refrigerant first pre-compression part 122 and the second flow of the first refrigerant pre-compressed by the first refrigerant second pre-compression part 132 may be mixed in a mixing pipe and supplied to the first refrigerant first compression part 110. Herein, as the first flow and the second flow are mixed with a pressure of the first refrigerant discharged from the first refrigerant first pre-compression part 122 and a pressure of the first refrigerant discharged from the first refrigerant second pre-compression part 132 being matched to each other and then are introduced into the first refrigerant first compression part 110, compression efficiency of the first refrigerant may be improved.

The first refrigerant second pre-compression part 132 and the first refrigerant second expansion part 131 may be provided as companders or turbo expanders operating in conjunction with each other. That is, the first refrigerant second pre-compression part 132 and the first refrigerant second expansion part 131 may have drive shafts connected or linked with each other to use expansion energy of the first refrigerant as pressurizing energy, and thus the efficiency of facility operation may be improved and the energy efficiency thereof may be increased by reducing power consumption of the facility.

As described above, in the first refrigerant cycle 100 according to the present embodiment, the first refrigerant compressed in the first refrigerant first compression part 110 is divided into the two flows, which circulate through different paths connected in parallel and perform heat exchange, and thus, not only process variables may be easily adjusted, but also the separation efficiency of heavy hydrocarbons and the liquefaction efficiency of natural gas may be improved by adjusting the flow of the first refrigerant to maximize cooling efficiency.

In addition, the first turbo expander 120 and the second turbo expander 130 according to the present embodiment may adjust a flow division ratio of the first refrigerant and cool divided flows to different temperatures so that the heat exchange efficiency of the cryogenic heat exchanger 300 or the cooling efficiency of natural gas may be improved. As an example, in the flow of the first refrigerant, about 25%-45% may be divided to a side having a relatively high process temperature and about 55%-75% may be divided to a side having a relatively low process temperature. The first refrigerant with divided flows may be introduced into the cryogenic heat exchanger 300, and a first cooling process of nature gas may be performed by being divided into a first cooling process (from about −55 °C~−75 °C to about 30 °C~45 °C) and a second cooling process (from about −90 °C~−115 °C to about 30 °C~45 °C). Specifically, the first turbo expander 120 may adjust the first cooling process by controlling a temperature difference between the first refrigerant and a fluid in a warm region corresponding to about −65 °C~30 °C with the first flow of the first refrigerant. In addition, the second turbo expander 130 may adjust the second cooling process by controlling a temperature difference between the first refrigerant and a fluid in an intermediate region corresponding to about −110 °C~−65 °C with the second flow of the first refrigerant.

The second refrigerant circulates through the second refrigerant cycle 200, some paths of which may perform heat exchange via the cryogenic heat exchanger 300. As described above, the second refrigerant may be made of nitrogen having a lower liquefaction point than that of the first refrigerant.

The second refrigerant cycle 200 may include a second refrigerant compression part 210 and a second refrigerant turbo expander 220. The second refrigerant compression part 210 is provided upstream of the cryogenic heat exchanger 300 in the second refrigerant cycle 200 and may compress the second refrigerant to a high pressure. For example, after passing through the second refrigerant compression part 210, the second refrigerant may be compressed to about 50 to 60 barg. The second refrigerant compression part 210 may be provided in a single stage, as illustrated in FIG. 1, and a cooler may be disposed on each of a front end side and a rear end side but is not limited thereto, and the second refrigerant compression part 210 may be provided in a plurality of stages, a cooler may be alternately arranged therebetween, and the number thereof may be variously changed.

The second refrigerant compressed by the second refrigerant compression part 210 may be cooled while passing through the warm heat exchange region 330 and the intermediate heat exchange region 320 of the cryogenic heat exchanger 300 and at least a part of the cold heat exchange region 310.

The second refrigerant compressed by the second refrigerant compression part 210 exchanges heat and is cooled while passing through the cryogenic heat exchanger 300, and then is supplied to a second refrigerant expansion part 221 side of the second refrigerant turbo expander 220. The second refrigerant turbo expander 220 includes the second refrigerant expansion part 221 and a second refrigerant pre-compression part 222. The second refrigerant expansion part 221 is provided downstream of the cold heat exchange region 310 of the cryogenic heat exchanger 300 in the second refrigerant cycle 200 and expands the second refrigerant having passed through the cryogenic heat exchanger 300. As an example, the second refrigerant may be expanded to about 10 to 18 barg by the second refrigerant expansion part 221 and cooled to about −150 °C to −165 °C.

The second refrigerant expanded and cooled by the second refrigerant expansion part 221 circulates to the cold heat exchange region 310, the intermediate heat exchange region 320, and the warm heat exchange region 330 of the cryogenic heat exchanger 300 to perform heat exchange and provide cold energy. Specifically, the second refrigerant, which is introduced from the second refrigerant expansion part 221 to the cryogenic heat exchanger 300, may perform heat exchange and provide cold energy by sequentially passing through the cold heat exchange region 310 (downstream region among the regions in cryogenic heat the heat exchanger with respect to the flow of natural gas), the intermediate heat exchange region 320 (midstream region), and the warm heat exchange region 330 (upstream region) in the cryogenic heat exchanger 300. That is, the second refrigerant may perform a process of a cold loop (from about −165 °C~−150 °C to 30 °C~45 °C) including an ultra cold section (about −165 °C to −110 °C) in which heat exchange may not be performed with the first refrigerant.

The second refrigerant, which has passed through the cold heat exchange region 310, the intermediate heat exchange region 320, and the warm heat exchange region 330 of the cryogenic heat exchanger 300, is supplied to the second refrigerant pre-compression part 222. Like the second refrigerant expansion part, the second refrigerant pre-compression part 222 is provided downstream of the cold heat exchange region 310 of the cryogenic heat exchanger 300 in the second refrigerant cycle 200. The second refrigerant pre-compression part 222 may preliminarily compress the supplied second refrigerant. As an example, the second refrigerant pre-compression part 222 may pre-compress the second refrigerant, which has been expanded by the second refrigerant expansion part 221 and has passed through the cryogenic heat exchanger 300 again, to about 15 to 30 barg and then supply the second refrigerant to the second refrigerant compression part 210.

The second refrigerant pre-compression part 222 and the second refrigerant expansion part 221 may be provided as companders or turbo expanders operating in conjunction with each other. That is, the second refrigerant pre-compression part 222 and the second refrigerant expansion part 221 may have drive shafts connected or linked with each other to use expansion energy of the second refrigerant as pressurizing energy, and thus the efficiency of facility operation may be improved and the energy efficiency thereof may be increased by reducing power consumption of the facility.

Thus, the natural gas liquefaction apparatus 10 according to the present embodiment may perform a cooling or liquefaction process of a liquid in stages by the first turbo expander 120, the second turbo expander 130, and the second refrigerant turbo expander 220 and easily adjust the cooling or liquefaction process at each stage. Besides, as described above, the flow rate of the second refrigerant of the second refrigerant cycle 200 may be reduced compared to that in related arts through an efficient process structure of the first refrigerant cycle 100.

The natural gas processing apparatus 20 is provided to receive cold energy from the natural gas liquefaction apparatus 10 and then separate heavy hydrocarbons contained in natural gas and liquefy the natural gas at the same time.

The natural gas processing apparatus 20 includes a scrub column 400 configured to receive natural gas, which is firstly cooled in the cryogenic heat exchanger 300, and firstly separate the natural gas into a gas component and a liquid component and a reflux drum 500 configured to receive the natural gas, which is the gas component separated at the scrub column 400 and secondarily cooled in the cryogenic heat exchanger 300, and secondarily separate the natural gas into a gas component and a liquid component.

The scrub column 400 may receive natural gas, which is supplied from a supply source such as a gas well and the like and is firstly cooled by passing through the cryogenic heat exchanger 300, and firstly separate the natural gas into a gas component and a liquid component. Specifically, the natural gas supplied from the supply source such as a gas well and the like is firstly cooled and partially liquefied by receiving cold energy while passing through the warm heat exchange region 330 (upstream region) of the cryogenic heat exchanger 300 and then is introduced into the scrub column 400. As described above, heavy hydrocarbons have a relatively higher liquefaction temperature than that of each of methane and ethane. Accordingly, the natural gas is cooled while passing through the warm heat exchange region 330 of the cryogenic heat exchanger 300, and the heavy hydrocarbons are firstly liquefied. Thus, the scrub column 400 receives the natural gas, which is firstly cooled while passing through the cryogenic heat exchanger 300, and separates the natural gas into the firstly liquefied heavy hydrocarbons (liquid component) and the gas component with relatively high contents of methane and ethane. Herein, the scrub column 400 may be partitioned into an upper section, a middle section, and a lower section according to relative heights, and the natural gas, which is firstly cooled while passing through the cryogenic heat exchanger 300, may be introduced into the middle section of the scrub column 400.

The liquid component, which is separated at the scrub column 400 and has a relatively high content of heavy hydrocarbons, may be produced as natural gas condensate through a condensate production line connected to a lower end of the scrub column 400, and the gas component, which is separated at the scrub column 400 and has relatively high contents of methane and ethane, may be delivered to the cryogenic heat exchanger 300 through an upper end of the scrub column 400. The liquid component separated at the scrub column 400 may be produced as natural gas condensate through the condensate production line, and the produced natural gas condensate may be supplied to a demanding site to be used as LPG, fuel of vehicles or airplanes, generation fuel, and the like. The gas component separated at the scrub column 400 may be secondarily cooled and partially liquefied by passing through the intermediate heat exchange region 320 (midstream region) of the cryogenic heat exchanger 300 and performing heat exchange, and the secondarily cooled gas component is supplied to the reflux drum 500.

The gas component firstly separated at the scrub column 400 is in a state in which heavy hydrocarbons have been largely removed, but some heavy hydrocarbons may be contained therein. Accordingly, the reflux drum 500 may receive the gas component, which is secondarily cooled by passing through the cryogenic heat exchanger 300, and secondarily separate the natural gas into the gas component into a gas component and a liquid component, thereby secondarily separating the heavy hydrocarbons. The gas component firstly separated at the scrub column 400 is secondarily cooled by passing through the intermediate heat exchange region 320 of the cryogenic heat exchanger 300, and thus the heavy hydrocarbons remaining in the gas component separated at the scrub column 400 are secondarily liquefied. The reflux drum 500 receives the natural gas, which is secondarily cooled while passing through the cryogenic heat exchanger 300, and separates the natural gas into the secondarily liquefied heavy hydrocarbons (liquid component) and the gas component with further enhanced contents of methane and ethane.

The liquid component, which is separated at the reflux drum 500 and has a relatively high content of heavy hydrocarbons, and is secondarily cooled by passing through the cryogenic heat exchanger 300, may be introduced into the scrub column 400 again through a lower end of the reflux drum 500. The liquid component introduced from the reflux drum 500 may be introduced into the upper section of the scrub column 400. To this end, a reflux pump configured to pressurize the liquid component separated at the reflux drum 500 and send the liquid component to the scrub column 400 may be provided. The reflux pump may be provided in the reflux drum 500 or provided on a transfer line connecting the lower end of the reflux drum 500 and the scrub column 400.

The liquid component introduced from the reflux drum 500 secondarily passes through the cryogenic heat exchanger 300 and is cooled, and thus has a temperature lower than that of the firstly cooled natural gas introduced into the middle section of the scrub column 400. Accordingly, as the liquid component introduced from the reflux drum 500 is introduced into the upper section of the scrub column 400, the inside of the scrub column 400 may be additionally cooled so that liquefaction of the heavy hydrocarbons in the scrub column 400 may be further promoted. Furthermore, the liquid component introduced from the reflux drum 500 may be sprayed at the upper section of the scrub column 400 so that the liquid component introduced from the reflux drum 500 may effectively liquefy the heavy hydrocarbons in the scrub column 400.

Meanwhile, a reboiler configured to heat the liquid component firstly separated at the scrub column 400 may be provided in the lower section of the scrub column 400. The liquid component firstly separated at the scrub column 400 mostly contains heavy hydrocarbons but may have methane or ethane as a partial content. Accordingly, the reboiler may heat the liquid component at a predetermined temperature to vaporize methane or ethane contained in the liquid component separated at the scrub column 400, and thus the content of methane and ethane of the gas component separated at the scrub column 400 may be raised.

The gas component secondarily separated at the reflux drum 500 is thirdly cooled and liquefied by passing through the cryogenic heat exchanger 300. Specifically, the gas component secondarily separated at the reflux drum 500 is cooled by sequentially passing through the warm heat exchange region 330 (upstream region), the intermediate heat exchange region 320 (midstream region), and the cold heat exchange region 310 (downstream region) of the cryogenic heat exchanger 300 and thus may be liquefied and at least partially supercooled. LNG cooled and at least partially supercooled when passing from the reflux drum through the cryogenic heat exchanger 300 may be supplied to a demanding site such as a storage tank, a fuel tank of a ship, and the like.

Hereinafter, a process simulation result of the gas management systems 1 and 2 according to the present embodiment will be described.

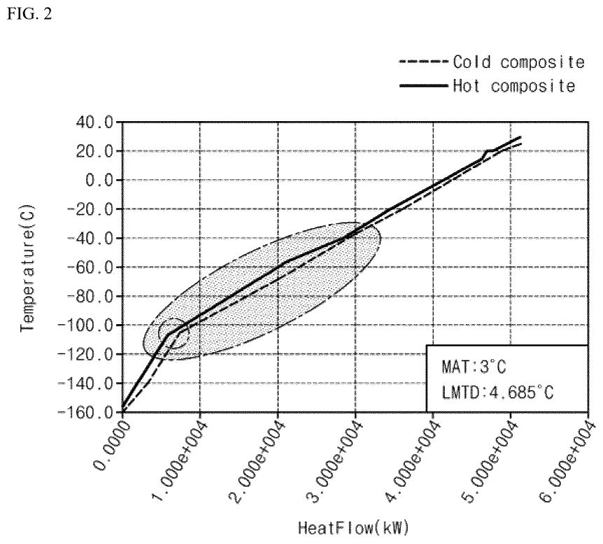

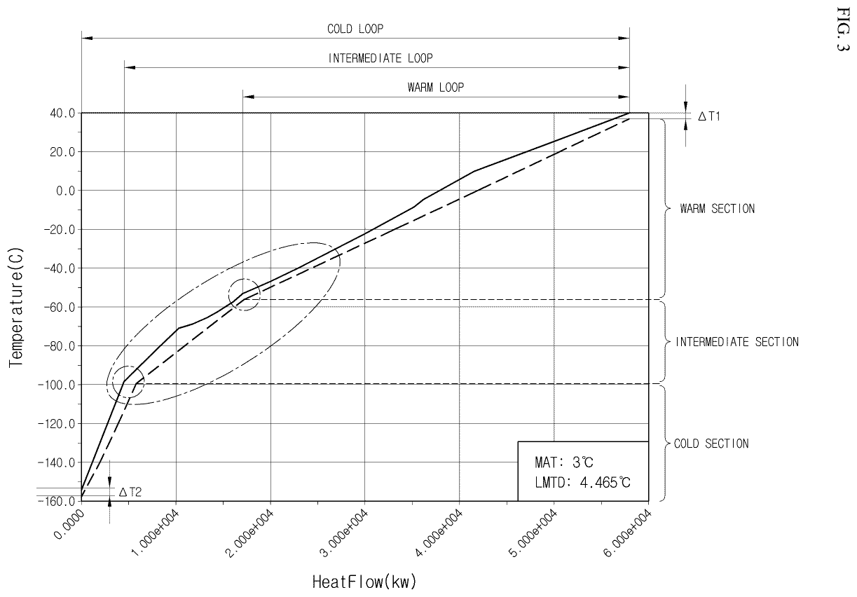

FIG. 2 is a graph illustrating a composite curve of a heat exchanger applied to a conventional natural gas liquefaction apparatus 10, and FIG. 3 is a view illustrating a composite curve of a cryogenic heat exchanger applied to a natural gas liquefaction apparatus 10 according to the present embodiment.

x-axes of the graphs illustrated in FIGS. 2 and 3 indicate heat flows generated in a heat exchanger through the heat amount of each of the turbo expanders and the compression parts, and γ-axes indicate temperatures. In addition, the temperature curve (hot composite) of natural gas located on the upper side is depicted as a solid line and the temperature curve (cold composite) of the refrigerant located on the lower side is depicted as a dotted line.

First, examining the conventional cooling apparatus, in the heat exchanger applied to the conventional cooling apparatus, two different types of refrigerants circulate through two cycles independent of each other to provide cold energy to natural gas.

Examining the composite curve illustrated in the graph of FIG. 2, it can be seen that a temperature difference between the hot composite as natural gas and the cold composite as the refrigerant is large in a range of about −40 °C to about −100 °C, and thus, it can be seen that an area formed between the hot composite and the cold composite is also larger than that of the cold region. This is because one refrigerant is formed in series by being transferred and circulating through one cycle in the conventional cooling apparatus and thus there is only one adjustable inflection point for maximizing liquefaction efficiency.

On the other hand, referring to the composite curve illustrated in the graph of FIG. 3, it can be seen that the temperature difference between the hot composite as natural gas and the cold composite as the refrigerant is small in the range of about-40 °C to about −100 °C, and thus, the area formed between the hot composite and the cold composite is minimized. This is because the first refrigerant cycle 100 is formed, unlike that in the related art, as parallel sections of the warm heat exchange region 330 (primary cooling, about 30 °C to −65 °C) and the intermediate heat exchange region 320 (secondary cooling, about 30 °C to −110 °C), and there are a plurality of adjustable inflection points for maximizing liquefaction efficiency.

The natural gas liquefaction apparatus 10 according to the present embodiment has the first refrigerant cycle 100 composed of a warm loop and an intermediate loop and the second refrigerant cycle 200 composed of a cold loop. Each loop is operated in various temperature ranges considering the temperature curve. For example, the intermediate loop through which the first refrigerant circulates is cooled to about −90 °C to −115 °C and may be operated until reaching about 25 °C to 45 °C, the warm loop through which the first refrigerant circulates is cooled to about −55 °C to −75 °C and may be operated until reaching about 25 °C to 45 °C, and the cold loop through which the second refrigerant circulates is cooled to about −150 °C to −165 °C and may be operated until reaching about 25 °C to 45 °C.

Changes in the amounts or ratios of the first refrigerant and the second refrigerant which circulate through the respective loops may substantially affect the temperature curve. Specifically, a change in the second flow of the first refrigerant circulating through the intermediate loop may substantially affect a liquefaction region between about −115 °C and −90 °C. In addition, a change in the first flow of the first refrigerant circulating through the warm loop may mainly have influence at about −90 °C or higher.

As such, the natural gas liquefaction apparatus 10 according to the present invention may effectively reduce the temperature curve difference between the fluid (natural gas) and each of the refrigerants in a temperature range section, which is mainly responsible for each loop by adjusting the first and second flows of the first refrigerant and the flow of the second refrigerant circulating through the respective loops and adjusting the temperatures of the respective loops. In addition, since a simple structure and a neat process enhance the compression efficiency of the refrigerants and effectively cool the natural gas, the energy consumed for liquefying the natural gas and separating the heavy hydrocarbons may be reduced, and the efficiency of the process may be improved.

The log mean temperature differences (LMTDs) illustrated in FIGS. 2 and 3 are log mean temperature differences between the hot composite of natural gas and the cold composite of the refrigerant. An LMTD, which analyzes an entire heat exchange process in a heat exchange by a mean temperature, is a mean value representing a temperature difference between the natural gas and the refrigerant. When ΔT1 is the difference between an inlet side temperature of natural gas in a heat exchanger and an outlet side temperature of a refrigerant in the heat exchanger, and ΔT2 is the difference between an outlet side temperature of the natural gas in the heat exchanger and an inlet side temperature of the refrigerant in the heat exchanger, the LMTD may be calculated as the value of [(ΔT1−ΔT2)/{(ln ΔT1)−(ln ΔT2)}].

Referring to FIGS. 2 and 3, when comparing the LMTDs of the composite curves of two processes, it may be found that the conventional cooling apparatus has an LMTD of 4.685 °C and the natural gas liquefaction apparatus 10 according to the present embodiment has that of 4.465 °C, and the natural gas liquefaction apparatus 10 according to the present embodiment has a smaller difference between the hot composite of the natural gas and the cold composite of the refrigerant, and this means that the cooling efficiency is improved.

In addition, unlike in related arts, since the natural gas liquefaction apparatus 10 according to the present embodiment efficiently performs a cooling process of at least about −110 °C in the first refrigerant cycle 100, the flow of the second refrigerant required in the second refrigerant cycle 200 may be reduced, and thus, the second refrigerant may be stably compressed only with a small number of the second refrigerant compression part 210 or a low specification thereof, so that the facility building and operation costs may be reduced.

In FIGS. 2 and 3, shaded portions represent a portion of a pre-cooling (primary cooling) process of natural gas and a liquefaction/partial liquefaction (secondary cooling) process. Comparing with FIG. 2, it can be seen that in the natural gas liquefaction apparatus 10 according to the present embodiment of FIG. 3, the difference between the temperature curve of the natural gas and the temperature curve of the refrigerant in the pre-cooling (primary cooling) process and the liquefaction/partial liquefaction (secondary cooling) process is narrowed.

This is because the first refrigerant cycle 100 is formed in parallel as the pre-cooling section (primary cooling, about 30 °C to −65 °C) and the partial liquefaction section (secondary cooling, about 30 °C to −110 °C), so that the pre-cooling section (about 30 °C to −65 °C) may be adjusted by the first flow of the first refrigerant, and the partial liquefaction section (about 30 °C to −110 °C) may be adjusted by the second flow of the first refrigerant, and a plurality of adjustable inflection points are present in the pre-cooling section (about 30 °C to −65 °C) and the partial liquefaction section (about 30 °C to −110 °C), and the pre-cooling and partial liquefaction processes may be separated and efficiently performed.

That is, in the natural gas liquefaction apparatus 10 according to the present embodiment, the heat exchange (third cooling and supercooling process) between the natural gas and the refrigerant in the ultra cold section (about −165 °C to −110 °C) may be adjusted by the second refrigerant cycle 200 in which the second refrigerant circulates through the cold loop, the heat exchange (secondary cooling and liquefaction/partial liquefaction process) between the natural gas and the refrigerant in the intermediate section (about −110 °C to −65 °C) may be adjusted by the first refrigerant cycle 100 in which the second flow of the first refrigerant circulates through the intermediate loop, and the heat exchange (primary cooling and pre-cooling process) between the natural gas and the refrigerant in the warm section (about −65 °C to 30 °C) may be adjusted by the first refrigerant cycle 100 in which the first flow of the first refrigerant circulates through the warm loop.

Accordingly, the first flow of the first refrigerant circulating through the warm loop, the second flow of the first refrigerant circulating through the intermediate loop, and the flow of the second refrigerant circulating through the cold loop are each adjusted to adjust the temperature difference between the fluid and the refrigerant for each loop so that the temperature curve difference between the fluid (natural gas) and the refrigerants may be effectively reduced in the temperature range section, which is mainly responsible for each loop.

In addition, as the pressures of the first refrigerant discharged from the first refrigerant first pre-compression part 122 and the first refrigerant second pre-compression part 132 are matched to each other, and the first refrigerants are mixed and then introduced into the first refrigerant first compression part 110, compression efficiency of the refrigerant may be improved. That is, as the natural gas liquefaction apparatus 10 according to the present embodiment enhances the compression efficiency of the refrigerants and effectively cools the natural gas with a simple structure and a neat process, the energy consumed for liquefying the natural gas and separating the heavy hydrocarbons may be reduced, and the efficiency of the process may be improved.

In Table 1 provided below, the yields and energy efficiencies of the natural gas liquefaction apparatus 10 according to the related art and the present embodiment are compared.

TABLE 1

| | | Present |
|---|---|---|
| | Related art | embodiment |
| Compressor Duty [MW] | 40.0 | 40.0 |
| LNG Production [MTPA] | 1.005 | 1.090 |
| Condensate | Production is | 0.24 |
| Production [MTPA] | impossible | |
| Specific Power | 14.42 | 10.89 |
| [kW/(ton/day)] | | |

Examining Table 1, as a process simulation result based on available capacity of 40.0 MW, it can be seen that the natural gas liquefaction apparatus 10 according to the present embodiment has available yields of 1.090 MTPA of LNG and 0.24 MTPA of condensate, which correspond to about 32.48% increase from the yield of 1.005 MTPA of LNG of the conventional cooling apparatus. In addition, it can be seen that the conventional cooling apparatus consumes 14.42 kW for LNG production of about 1 ton/day, while the natural gas liquefaction apparatus 10 according to the present embodiment reduces the consumption to 10.89 kW despite producing condensate together with LNG so that the energy consumption is reduced by about 32.4%.

Thus, the gas management systems 1 and 2 according to the present embodiment may reduce facility building and operation costs since the heavy hydrocarbons are separated by receiving the cold energy during a process of liquefying the natural gas without building a separate facility for separating the heavy hydrocarbons from the natural gas. Furthermore, as energy efficiency is increased, efficient facility operation may be promoted.

Hereinafter, the gas management system 2 according to the present invention will be described.

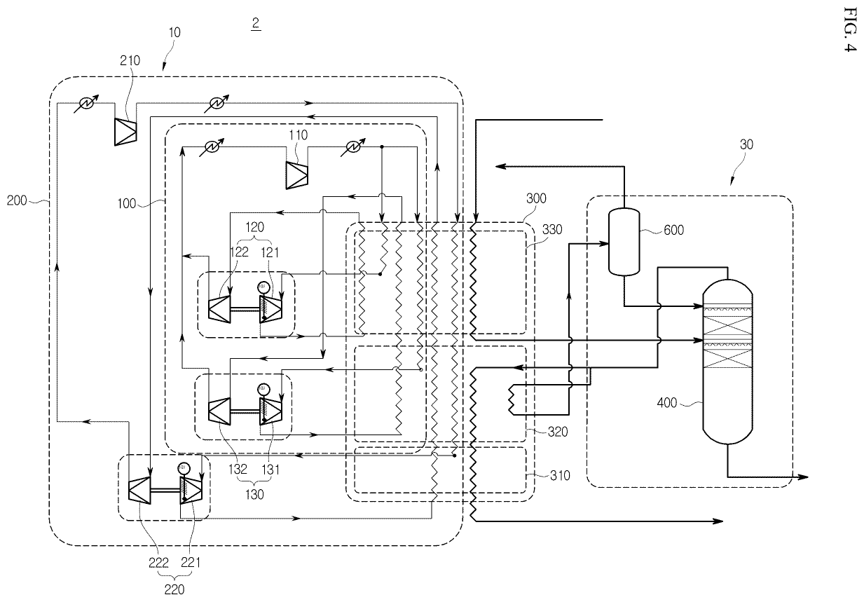

FIG. 4 is a conceptual diagram illustrating a gas management system 2 according to a second embodiment of the present invention, and referring to FIG. 4, the gas management system 2 according to the second embodiment of the present invention may include a natural gas processing apparatus 30 configured to separate heavy hydrocarbons contained in natural gas and a natural gas liquefaction apparatus 10 configured to promote separation of the heavy hydrocarbons and implement liquefaction of the natural gas by providing cold energy to the natural gas.

In the following description of the gas management system 2 according to the second embodiment of the present disclosure, the same reference numerals will be used to refer to the same elements in the description of the gas management system 1 according to the first embodiment of the present invention unless otherwise specifically noted, and thus description thereof will be omitted in order to avoid duplication of contents.

The natural gas processing apparatus 30 is provided to receive cold energy from the natural gas liquefaction apparatus 10 and then separate heavy hydrocarbons contained in natural gas and liquefy the natural gas at the same time.

The natural gas processing apparatus 30 includes a scrub column 400 configured to receive natural gas, which is firstly cooled in the cryogenic heat exchanger 300, and firstly separate the natural gas into a gas component and a liquid component and a reflux drum 600 configured to receive the natural gas, which is the gas component separated at the scrub column 400 and secondarily cooled in the cryogenic heat exchanger 300, and secondarily separate the natural gas into a gas component and a liquid component.

The scrub column 400 may receive natural gas, which is supplied from a supply source such as a gas well and the like and is firstly cooled by passing through the cryogenic heat exchanger 300, and firstly separate the natural gas into a gas component and a liquid component. Specifically, the natural gas supplied from the supply source such as a gas well and the like is firstly cooled and partially liquefied by receiving cold energy while passing through the warm heat exchange region 330 (upstream region) of the cryogenic heat exchanger 300 and then is introduced into the scrub column 400.

As described above, heavy hydrocarbons have a relatively higher liquefaction temperature than that of each of methane and ethane. Accordingly, the natural gas is cooled while passing through the warm heat exchange region 330 of the cryogenic heat exchanger 300, and the heavy hydrocarbons are firstly liquefied. Thus, the scrub column 400 receives the natural gas, which is firstly cooled while passing through the cryogenic heat exchanger 300, and separate the natural gas into the firstly liquefied heavy hydrocarbons (liquid component) and the gas component including methane and ethane. Herein, the scrub column 400 may be partitioned into an upper section, a middle section, and a lower section according to relative heights, and the natural gas, which is firstly cooled while passing through the cryogenic heat exchanger 300, may be introduced into the middle section of the scrub column 400.

The liquid component, which is separated at the scrub column 400 and has a relatively high content of heavy hydrocarbons, may be produced as natural gas condensate through a condensate production line connected to a lower end of the scrub column 400, and the gas component, which is separated at the scrub column 400 and is composed of methane and ethane, may be delivered to the cryogenic heat exchanger 300 through an upper end of the scrub column 400. The liquid component separated at the scrub column 400 may be produced as natural gas condensate through the condensate production line, and the produced natural gas condensate may be supplied to a demanding site to be used as LPG, fuel of vehicles or airplanes, generation fuel, and the like. The gas component separated at the scrub column 400 may be secondarily cooled and liquefied by passing through the intermediate heat exchange region 320 (midstream region) of the cryogenic heat exchanger 300 and performing heat exchange.

The gas component separated at the scrub column 400 is in a state with very high contents of methane and ethane and may be divided into two flows, each of which may be individually handled. Specifically, the gas component firstly separated at the scrub column 400 is in a state in which heavy hydrocarbons have been largely removed, but some heavy hydrocarbons may be contained therein. Accordingly, a first flow of the two divided flows of the gas component separated at the scrub column 400 may be secondarily cooled by passing through the cryogenic heat exchanger 300 and then may be supplied to the reflux drum 600. The reflux drum 600 may receive the first flow of the gas component, which is secondarily cooled by passing through the cryogenic heat exchanger 300, and secondarily separate a liquid component, thereby secondarily separating the heavy hydrocarbons. The first flow of the gas component firstly separated at the scrub column 400 is secondarily cooled by passing through the intermediate heat exchange region 320 of the cryogenic heat exchanger 300, and thus the heavy hydrocarbons remaining in the first flow of the gas component separated at the scrub column 400 are secondarily liquefied. The reflux drum 600 receives the first flow of the gas component, which is secondarily cooled while passing through the cryogenic heat exchanger 300, separates the secondarily liquefied heavy hydrocarbons (liquid component), and then circulates the liquid component to the scrub column 400 again.

The liquid component, which is separated at the reflux drum 600 and has a relatively high content of heavy hydrocarbons, and is secondarily cooled by passing through the cryogenic heat exchanger 300, may be introduced into the scrub column 400 again through a lower end of the reflux drum 600. The liquid component introduced from the reflux drum 600 may be introduced into the upper section of the scrub column 400. To this end, a reflux pump configured to pressurize the liquid component separated at the reflux drum 600 and send the liquid component to the scrub column 400 may be provided. The reflux pump may be provided in the reflux drum 600 or provided on a transfer line connecting the lower end of the reflux drum 600 and the scrub column 400.

The liquid component introduced from the reflux drum 600 secondarily passes through the cryogenic heat exchanger 300 and is cooled, and thus has a temperature lower than that of the firstly cooled natural gas introduced into the middle section of the scrub column 400. Accordingly, as the liquid component introduced from the reflux drum 600 is introduced into the upper section of the scrub column 400, the inside of the scrub column 400 may be additionally cooled so that liquefaction of the heavy hydrocarbons in the scrub column 400 may be further promoted. Furthermore, the liquid component introduced from the reflux drum 600 may be sprayed at the upper section of the scrub column 400 so that the liquid component introduced from the reflux drum 600 may effectively liquefy the heavy hydrocarbons in the scrub column 400.

Meanwhile, a reboiler configured to heat the liquid component firstly separated at the scrub column 400 may be provided in the lower section of the scrub column 400. The liquid component firstly separated at the scrub column 400 mostly contains heavy hydrocarbons but may have methane or ethane as a partial content. Accordingly, the reboiler may heat the liquid component at a predetermined temperature to vaporize methane or ethane contained in the liquid component separated at the scrub column 400, and thus the content of methane and ethane of the gas component separated at the scrub column 400 may be raised.

A second flow of the two divided flows of the gas component separated at the scrub column 400 is secondarily cooled and liquefied by passing through the cryogenic heat exchanger 300. Specifically, since the gas component firstly separated at the scrub column 400 is in a state in which heavy hydrocarbons have been largely removed, for the efficient operation of the facility, the second flow of the gas component firstly separated at the scrub column 400 may be cooled and at least partially supercooled by sequentially passing through the intermediate heat exchange region 320 (midstream region) and the cold heat exchange region 310 (downstream region) and thus may be liquefied. After being liquefied and at least partially supercooled by passing through the cryogenic heat exchanger 300, the second flow of the gas component separated at the scrub column 400 may be supplied to a demanding site such as a storage tank, a fuel tank of a ship, and the like.

[Description of Symbols]

1, 2: gas management system
10: natural gas liquefaction apparatus
100: first refrigerant cycle
110: first refrigerant first compression part
120: first refrigerant first turbo expander
121: first refrigerant first expansion part
122: first refrigerant first pre-compression part
130: first refrigerant second turbo expander
131: first refrigerant second expansion part
132: first refrigerant second pre-compression part
200: second refrigerant cycle
210: second refrigerant compression part
220: second refrigerant turbo expander
221: second refrigerant expansion part
222: second refrigerant pre-compression part
300: cryogenic heat exchanger
310: cold heat exchange region
320: intermediate heat exchange region
330: warm heat exchange region
20, 30: natural gas processing apparatus
400: scrub column
500, 600: reflux drum

1. A gas management system comprising:
a natural gas processing apparatus configured to separate heavy hydrocarbons contained in natural gas; and
a natural gas liquefaction apparatus configured to provide cold energy to the natural gas,
wherein the natural gas liquefaction apparatus includes: a cryogenic heat exchanger in which the natural gas passes through and is liquefied into liquefied natural gas (LNG) through heat exchange with a first refrigerant and a second refrigerant;
a first refrigerant cycle in which the first refrigerant circulates, some paths pass through the cryogenic heat exchanger to perform heat exchange, and a path of the first refrigerant is divided into a plurality of paths after performing heat exchange in the cryogenic heat exchanger to perform expansion and pre-compression of the first refrigerant; and
a second refrigerant cycle in which the second refrigerant circulates and some paths pass through the cryogenic heat exchanger,
the first refrigerant cycle includes: a first refrigerant first compression part provided upstream of the cryogenic heat exchanger and configured to compress the first refrigerant to a high pressure;
a first refrigerant first turbo expander including a first refrigerant first expansion part provided downstream of the cryogenic heat exchanger and configured to expand a first flow of two divided flows of the first refrigerant having passed through the cryogenic heat exchanger, and a first refrigerant first pre-compression part configured to pre-compress the first refrigerant which has been expanded by the first refrigerant first expansion part and has passed through the cryogenic heat exchanger again;
a first refrigerant second turbo expander including a first refrigerant second expansion part provided downstream of the cryogenic heat exchanger and configured to expand a second flow of the two divided flows of the first refrigerant having passed through the cryogenic heat exchanger and a first refrigerant second pre-compression part configured to pre-compress the first refrigerant which has been expanded by the first refrigerant second expansion part and has passed through the cryogenic heat exchanger again; and
a mixing pipe where the first flow of the first refrigerant pre-compressed by the first refrigerant first pre-compression part and the second flow of the first refrigerant pre-compressed by the first refrigerant second pre-compression part are mixed,
the natural gas processing apparatus includes: a scrub column configured to receive natural gas firstly cooled through heat exchange performed in the cryogenic heat exchanger and firstly separate the natural gas into a gas component and a liquid component while the introduced natural gas passes through the cryogenic heat exchanger and performs heat exchange; and
a reflux drum configured to receive secondarily cooled natural gas by performing heat exchange in the cryogenic heat exchanger and secondarily separate the natural gas into a gas component and a liquid component while the gas component separated at the scrub column passes through the cryogenic heat exchanger and performs heat exchange, and
the gas component separated at the reflux drum is thirdly cooled and liquefied by passing through the cryogenic heat exchanger and performing heat exchange.

2. The gas management system of claim 1, wherein the liquid component separated at the reflux drum is introduced into the scrub column.

3. The gas management system of claim 2, wherein the scrub column includes an upper section and a middle section, and
the natural gas firstly cooled by performing heat exchange in the cryogenic heat exchanger is introduced into the middle section.

4. The gas management system of claim 3, wherein the liquid component separated at the reflux drum is introduced into the upper section.

5. The gas management system of claim 4, wherein the liquid component separated at the reflux drum is sprayed in the upper section.

6. The gas management system of claim 2, wherein the natural gas processing apparatus further includes a reflux pump configured to pressurize the liquid component separated at the reflux drum and send the liquid component to the scrub column.

7. The gas management system of claim 4, wherein the scrub column includes a reboiler configured to heat the liquid component firstly separated at the scrub column.

8. The gas management system of claim 7, wherein the scrub column further includes a lower section, and
the reboiler is provided in the lower section.

9. The gas management system of claim 1, wherein the first flow of the first refrigerant expanded by the first refrigerant first expansion part is introduced into an upstream region among the upstream region, a midstream region, and a downstream region in the cryogenic heat exchanger with respect to the flow of the natural gas, and passes through the upstream region without passing through the downstream region and the midstream region and then is introduced into the first refrigerant first pre-compression part,
the second flow of the first refrigerant expanded by the first refrigerant second expansion part is introduced into the midstream region in the cryogenic heat exchanger, and sequentially passes through the midstream region and the upstream region without passing through the downstream region and then is introduced into the first refrigerant second pre-compression part,
the second refrigerant cycle has the second refrigerant sequentially passing through the downstream region, the midstream region, and the upstream region among the inner regions in the cryogenic heat exchanger with respect to the flow of the natural gas, and
the natural gas introduced into the natural gas processing apparatus is introduced into and pass through the upstream region in the cryogenic heat exchanger and then is introduced into the scrub column.

10. The gas management system of claim 9, wherein the gas component separated at the scrub column is introduced into and passes through the midstream region in the cryogenic heat exchanger and then is introduced into the reflux drum.

11. The gas management system of claim 10, wherein the gas component separated at the reflux drum is introduced into the cryogenic heat exchanger, and cooled and liquefied by sequentially passing through the upper region, the midstream region, and the downstream region.

12. The gas management system of claim 1, wherein the second refrigerant cycle includes: a second refrigerant compression part provided upstream of the cryogenic heat exchanger and configured to compress the second refrigerant to a high pressure; and
a second refrigerant turbo expander including a second refrigerant expansion part provided downstream of the cryogenic heat exchanger and configured to expand the second refrigerant having passed through the cryogenic heat exchanger and a second refrigerant pre-compression part configured to pre-compress the second refrigerant which has been expanded by the second refrigerant expansion part and has passed through the cryogenic heat exchanger again.

13. The gas management system of claim 1, wherein the first refrigerant includes methane or LNG boil-off gas, and the second refrigerant includes nitrogen.

14. The gas management system of claim 1, wherein the liquid component separated at the scrub column is produced as natural gas condensate.

15. The gas management system of claim 1, wherein the first refrigerant first compression part is provided as a plurality of first refrigerant first compression parts, and the first refrigerant mixed in the mixing pipe is introduced into a first refrigerant first compression part of the first refrigerant first compression parts connected in series.

16. A gas management system comprising:
a natural gas processing apparatus configured to separate heavy hydrocarbons contained in natural gas; and
a natural gas liquefaction apparatus configured to provide cold energy to the natural gas,
wherein the natural gas liquefaction apparatus includes: a cryogenic heat exchanger in which the natural gas passes through and is liquefied into LNG through heat exchange with a first refrigerant and a second refrigerant;
a first refrigerant cycle in which the first refrigerant circulates, some paths pass through the cryogenic heat exchanger to perform heat exchange, and a path of the first refrigerant is divided into a plurality of paths after performing heat exchange in the cryogenic heat exchanger to perform expansion and pre-compression of the first refrigerant; and
a second refrigerant cycle in which the second refrigerant circulates and some paths pass through the cryogenic heat exchanger,
the first refrigerant cycle includes: a first refrigerant first compression part provided upstream of the cryogenic heat exchanger and configured to compress the first refrigerant to a high pressure;
a first refrigerant first turbo expander including a first refrigerant first expansion part provided downstream of the cryogenic heat exchanger and configured to expand a first flow of two divided flows of the first refrigerant having passed through the cryogenic heat exchanger, and a first refrigerant first pre-compression part configured to pre-compress the first refrigerant which has been expanded by the first refrigerant first expansion part and has passed through the cryogenic heat exchanger again;
a first refrigerant second turbo expander including a first refrigerant second expansion part provided downstream of the cryogenic heat exchanger and configured to expand a second flow of the two divided flows of the first refrigerant having passed through the cryogenic heat exchanger and a first refrigerant second pre-compression part configured to pre-compress the first refrigerant which has been expanded by the first refrigerant second expansion part and has passed through the cryogenic heat exchanger again; and
a mixing pipe where the first flow of the first refrigerant pre-compressed by the first refrigerant first pre-compression part and the second flow of the first refrigerant pre-compressed by the first refrigerant second pre-compression part are mixed,
the natural gas processing apparatus includes: a scrub column configured to receive natural gas firstly cooled through heat exchange performed in the cryogenic heat exchanger and firstly separate the natural gas into a gas component and a liquid component while the introduced natural gas passes through the cryogenic heat exchanger and performs heat exchange; and
a reflux drum configured to receive a first flow of two divided flows of the gas component separated at the scrub column and secondarily cooled by performing heat exchange in the cryogenic heat exchanger, the first flow performing heat exchange by passing through the cryogenic heat exchanger, and
a second flow of the two divided flows of the gas component separated at the scrub column is secondarily cooled and liquefied by passing through the cryogenic heat exchanger and performing heat exchange.

17. The gas management system of claim 16, wherein the reflux drum receives the cooled first flow and secondarily separates the liquid component.

18. The gas management system of claim 16, wherein the reflux drum receives the cooled first flow and secondarily separates the gas component.

19. The gas management system of claim 17, wherein the liquid component separated at the reflux drum is introduced into the scrub column.

20. The gas management system of claim 19, wherein the scrub column includes an upper section and a middle section, and
the natural gas firstly cooled by performing heat exchange in the cryogenic heat exchanger is introduced into the middle section.

21. The gas management system of claim 20, wherein the liquid component separated at the reflux drum is introduced into the upper section.

22. The gas management system of claim 21, wherein the liquid component separated at the reflux drum is sprayed in the upper section.

23. The gas management system of claim 19, wherein the natural gas processing apparatus further includes a reflux pump configured to pressurize the liquid component separated at the reflux drum and send the liquid component to the scrub column.

24. The gas management system of claim 21, wherein the scrub column includes a reboiler configured to heat the liquid component firstly separated at the scrub column.

25. The gas management system of claim 24, wherein the scrub column further includes a lower section, and
the reboiler is provided in the lower section.

26. The gas management system of claim 16, wherein the first flow of the first refrigerant expanded by the first refrigerant first expansion part is introduced into an upstream region among the upstream region, a midstream region, and a downstream region in the cryogenic heat exchanger with respect to the flow of the natural gas, and passes through the upstream region without passing through the downstream region and the midstream region and then is introduced into the first refrigerant first pre-compression part,
the second flow of the first refrigerant expanded by the first refrigerant second expansion part is introduced into the midstream region in the cryogenic heat exchanger, and sequentially passes through the midstream region and the upstream region without passing through the downstream region and then is introduced into the first refrigerant second pre-compression part,
the second refrigerant cycle has the second refrigerant sequentially passing through the downstream region, the midstream region, and the upstream region among the regions in the cryogenic heat exchanger with respect to the flow of the natural gas, and
the natural gas introduced into the natural gas processing apparatus is introduced into and pass through the upstream region in the cryogenic heat exchanger, and then is introduced into the scrub column.

27. The gas management system of claim 26, wherein the first flow of the gas component separated at the scrub column is introduced into and passes through the midstream region in the cryogenic heat exchanger, and then is introduced into the reflux drum.

28. The gas management system of claim 27, wherein the second flow of the gas component separated at the scrub column is cooled and liquefied by sequentially passing through the midstream region and the downstream region in the cryogenic heat exchanger.

29. The gas management system of claim 16, wherein the second refrigerant cycle includes: a second refrigerant compression part provided upstream of the cryogenic heat exchanger and configured to compress the second refrigerant to a high pressure; and
a second refrigerant turbo expander including a second refrigerant expansion part provided downstream of the cryogenic heat exchanger and configured to expand the second refrigerant having passed through the cryogenic heat exchanger and a second refrigerant pre-compression part configured to pre-compress the second refrigerant which has been expanded by the second refrigerant expansion part and has passed through the cryogenic heat exchanger again.

30. The gas management system of claim 16, wherein the first refrigerant includes methane or LNG boil-off gas, and the second refrigerant includes nitrogen.

31. The gas management system of claim 16, wherein the liquid component separated at the scrub column is produced as natural gas condensate.

32. The gas management system of claim 16, wherein the first refrigerant first compression part is provided as a plurality of first refrigerant first compression parts, and the first refrigerant mixed in the mixing pipe is introduced into a first refrigerant first compression part of the first refrigerant first compression parts connected in series.
